(19) United States
(12) Patent Application Publication
(10) Pub. No.: US 2006/0156867 A1
(43) Pub. Date: Jul. 20, 2006

(54) Three-dimensionally operable wrench

(76) Inventor: Chih-Ching Hsieh, Feng Yuan City (TW)

Correspondence Address: TROXELL LAW OFFICE PLLC, 5205 LEESBURG PIKE, SUITE 1404, FALLS CHURCH, VA, 22041, US

(21) Appl. No.: 11/117,323

(22) Filed: Apr. 29, 2005

(30) Foreign Application Priority Data
Jan. 17, 2005 (TW) 094101352

(51) Int. Cl. B25B 13/46; B25B 23/16; B25G 1/00

(52) U.S. Cl. 81/60; 81/177.7; 81/177.8; 81/177.75

(57) ABSTRACT

A three-dimensionally operable wrench including a head, a handle and a connecting member disposed between the head and the handle. A rear end of the head and a front end of the connecting member are pivotally connected via a first shaft pin. A rear end of the connecting member and a front end of the handle are pivotally connected via a second shaft pin. The first and second shaft pins are perpendicular to each other. The head and the connecting member can be swung relative to each other and the connecting member and the handle can be swung relative to each other. The swinging direction of the former is perpendicular to the swinging direction of the latter. By means of such complex swinging relationship, the handle can be swung by any angle relative to the head, whereby the wrench is adaptable to various working sites.

### BACKGROUND OF THE INVENTION

The present invention is related to a hand tool, and more particularly to a three-dimensionally operable wrench the using mode of which is changeable according to different application spaces. Therefore, the wrench can be more conveniently operated.

A wrench is used to wrench a screwed member in various sites. In some cases, a user needs to operate the wrench in a quite narrow space or in a quite hard condition. Under such circumstance, it will be a task to wrench a screwed member with the wrench.

FIG. 1 shows a conventional wrench 10 having a head 14 pivotally connected with one end of a handle 12. The head 14 can be swung, whereby the angle contained between the head 14 and the handle 12 is changeable according to the working site. Such wrench can be more conveniently used. However, the head 14 can be simply bent up or down by a certain angle. Therefore, the use of such wrench is still quite limited to certain sites.

### SUMMARY OF THE INVENTION

It is therefore a primary object of the present invention to provide a three-dimensionally operable wrench the using mode of which is adjustable according to various working sites. Therefore, the application range of the wrench is widened.

The present invention can be best understood through the following description and accompanying drawings wherein:

### BRIEF DESCRIPTION OF THE DRAWINGS

FIG. 1 is a perspective view of a conventional wrench;

FIG. 2 is a perspective view of a preferred embodiment of the present invention;

FIGS. 3 to 5 show the operation of the wrench of FIG. 2, in which FIG. 5 is a front view of the head of the wrench;

FIGS. 6 to 8 show that the handle is swung by different angles;

FIG. 9 is a perspective view of another embodiment of the present invention;

FIG. 10 is a longitudinal sectional view according to FIG. 9;

FIG. 11 is a view according to FIG. 10, showing that the rear end of the connecting member is inserted into the cave of the handle;

FIG. 12 is a top partially sectional view according to FIG. 9;

FIG. 13 is a side partially sectional view of still another embodiment of the present invention;

FIG. 14 is a top partially sectional view of still another embodiment of the present invention;

FIG. 15 is a top partially sectional view of still another embodiment of the present invention;

FIG. 16 is a perspective view of still another embodiment of the present invention;

FIG. 17 is a perspective exploded view according to FIG. 16;

FIG. 18 is a perspective view of still another embodiment of the present invention;

FIG. 19 is a perspective exploded view according to FIG. 18;

FIG. 20 is a perspective view of still another embodiment of the present invention;

FIG. 21 is a longitudinal sectional view according to FIG. 20;

FIG. 22 is a sectional view taken along line 22-22 of FIG. 21; and

FIG. 23 is a perspective view showing another using mode of the embodiment of FIG. 20.

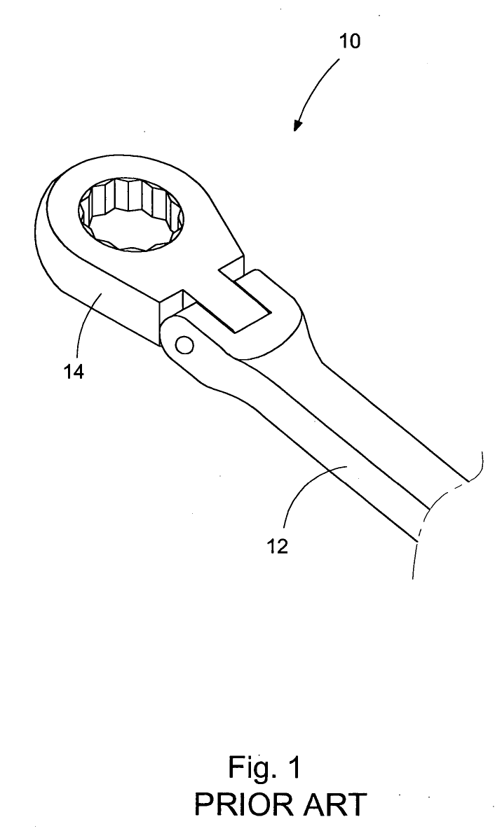

### DETAILED DESCRIPTION OF THE PREFERRED EMBODIMENTS

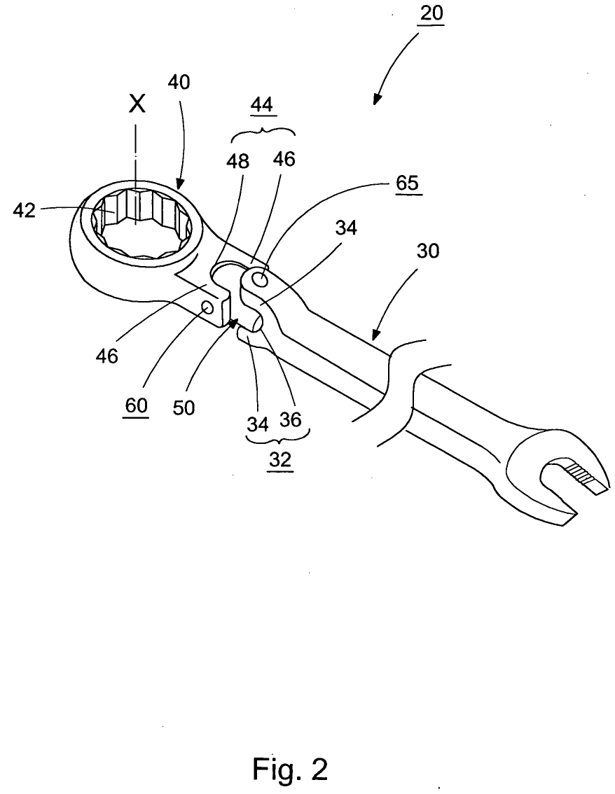

Please refer to FIG. 2. The three-dimensionally operable wrench 20 of the present invention has a handle 30, a head 40 and a connecting member 50 connected between the head 40 and the handle 30. By means of the connecting member 50, the head and the handle can be rotated up and down and left and right relative to each other.

A front end of the handle 30 is formed with a coupling portion 32 having an upper and a lower lugs 34. The lugs 34 define therebetween a recess 36.

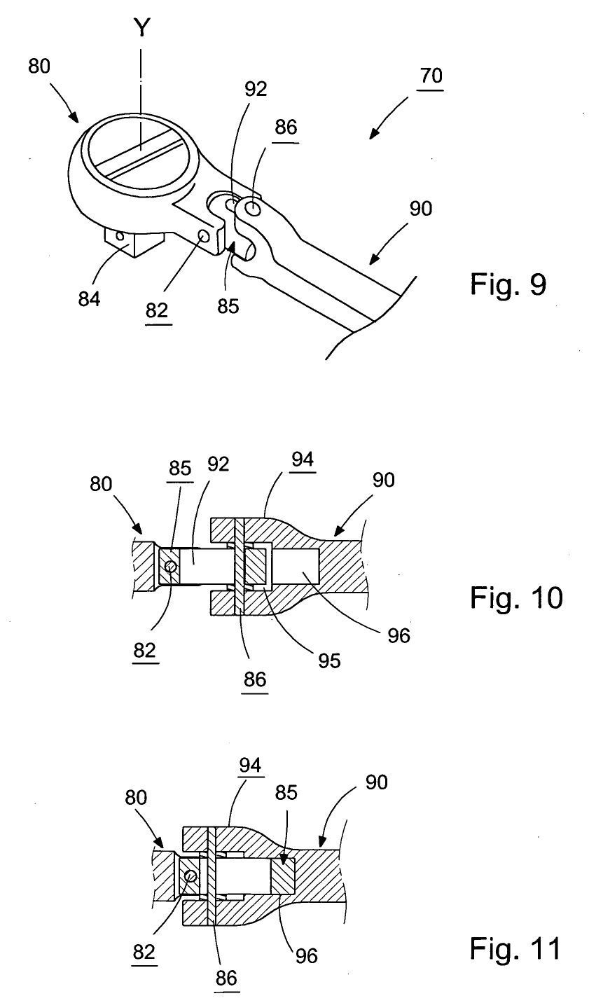

The head 40 is formed with a fitting hole 42 or a square connector 84 as shown in FIG. 9 for driving a nut or a bolt or a socket. The head is preferably equipped with a ratchet mechanism. Furthermore, the head 40 is fitted onto a screwed member or socket in a direction of a fitting axis X. A rear end of the head 40 has a pivot portion 44. The pivot portion 40 has a left and a right lugs 46 which define therebetween a recess 48.

In this embodiment, the connecting member 50 is a cylindrical member, a hexagonal column or a square column. A front end and a rear end of the connecting member are respectively pivotally connected the head 40 and the handle 30. The front end of the connecting member is fitted in the recess 48 of the pivot portion 44 of the head 40. The rear end of the connecting member is fitted in the recess 36 of the coupling portion 32 of the handle 30.

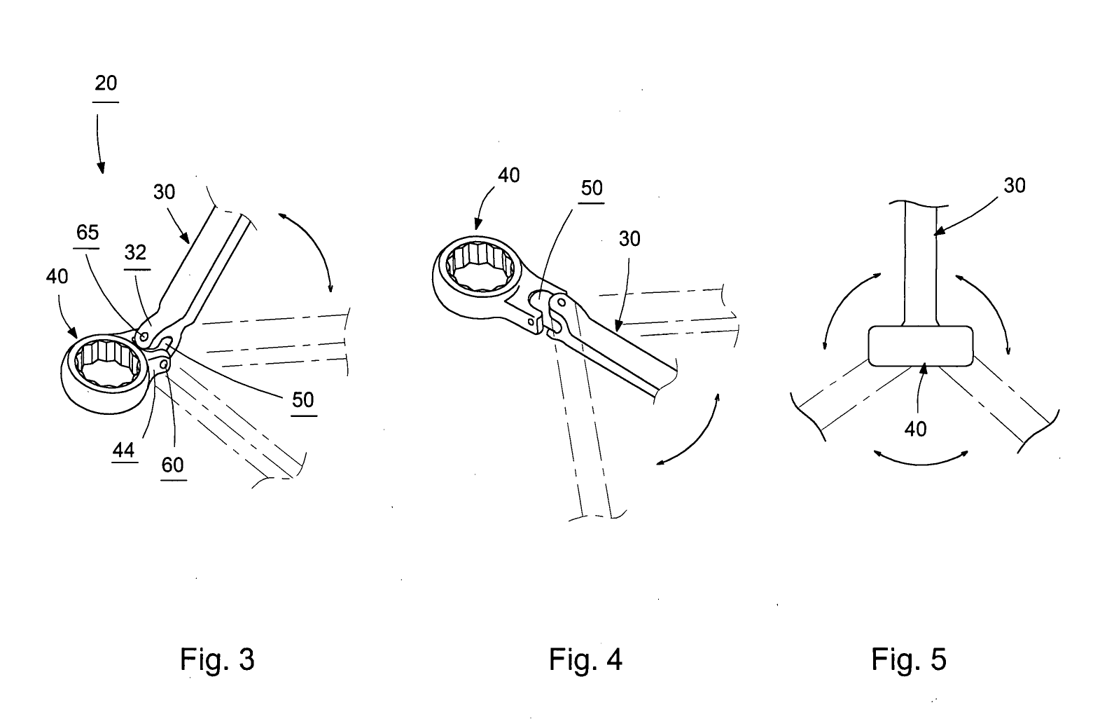

A first shaft pin 60 is fitted through a pivot hole of the pivot portion 44 and the front end of the connecting member 50 to pivotally connect the head 40 with the front end of the connecting member. A second shaft pin 65 is fitted through a pivot hole of the coupling portion 32 and the rear end of the connecting member 50 to pivotally connect the handle 30 with the rear end of the connecting member. The axes of the two shaft pins 60, 65 are perpendicular to each other. In this embodiment, the first shaft pin 60 is perpendicular to the axis X of the head. Referring to FIG. 3, by means of the pivot structures of the head 30 and the connecting member 50, the handle 40 and the connecting member 50 can be up and down swung relative to the head. By means of the pivot structures of the handle 40 and the connecting member 50, the handle 40 can be left and right swung relative to the head 30 and the connecting member 50 as shown in FIG. 4. By means of such complex pivot joint, the handle 40 can be three-dimensionally 360 degrees swung relative to the head 30 as shown in FIG. 5.

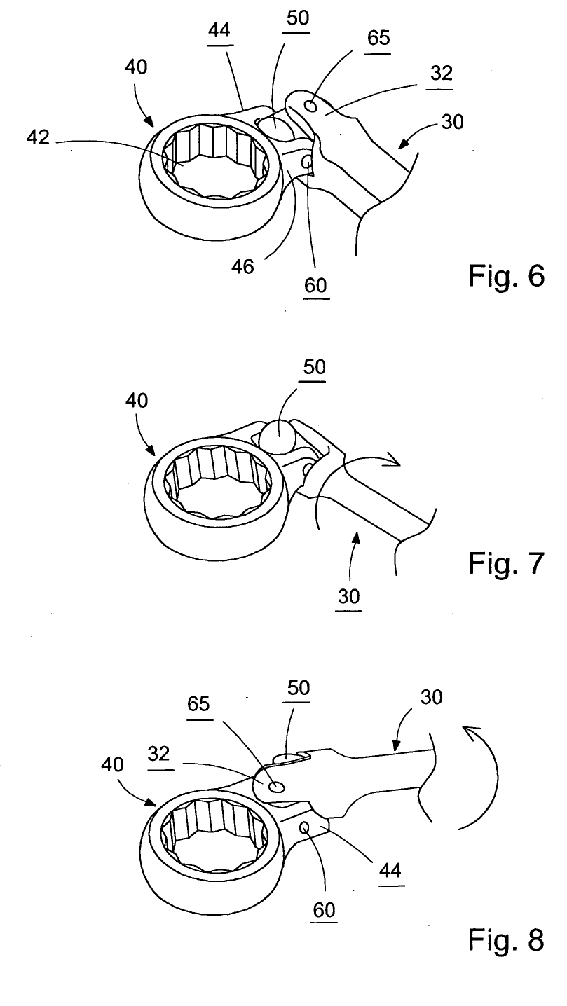

In use, as shown in FIG. 6, when the handle 30 is positioned in a dead end where the handle abuts against a lug 46 of the head, the action force applied to the handle can be truly transmitted to the head. At this time, by means of wrenching the handle, the head 40 can be rotated to drive a screwed member or a socket. Moreover, the handle 30 can be freely 360 degrees swung to any angular position according to the requirement of the working site. Therefore, the wrench 20 can be operated in various conditions. For example, in FIG. 6, the handle is horizontally placed. In FIG. 7, the handle is rotated to make the rear end thereof face downward. In FIG. 8, the rear end of the handle faces upward. In any angle, the handle can drive the head to wrench the screwed member.

FIG. 9 shows another embodiment of the wrench 70 of the present invention. Similarly, the rear end of the head 80 is pivotally connected with the front end of the connecting member 85 via the first shaft pin 82. The front end of the handle 90 is pivotally connected with the rear end of the connecting member via the second shaft pin 86. The two shaft pins 82, 86 are perpendicular to each other. The second shaft pin 86 is parallel to the fitting axis Y of the head 80.

The connecting member 85 is formed with a slot 92 with a certain length. The slot 92 axially passes through the connecting member 85 from top face to bottom face thereof as shown in FIG. 10. The longitudinal direction of the slot 92 is perpendicular to the first shaft pin 82. The second shaft pin 86 passes through the coupling portion 94 of the handle 90 and extends through the slot 92 to pivotally connect the handle with the connecting member. In addition, the front end of the handle 90 is further inward recessed from the recess 95 of the coupling portion 94 to form a cave 96. The cave 96 is aligned with the rear end of the connecting member 85. By means of the slot 92, the handle 90 and the connecting member 85 are slidable relative to each other.

In the state of FIGS. 9 and 10, the rear end of the connecting member 85 is not inserted into the cave 96. Therefore, the handle can be 360 degrees swung about the two shaft pins 82, 86 relative to the head. The operation in this state is identical to that of the embodiment of FIG. 2.

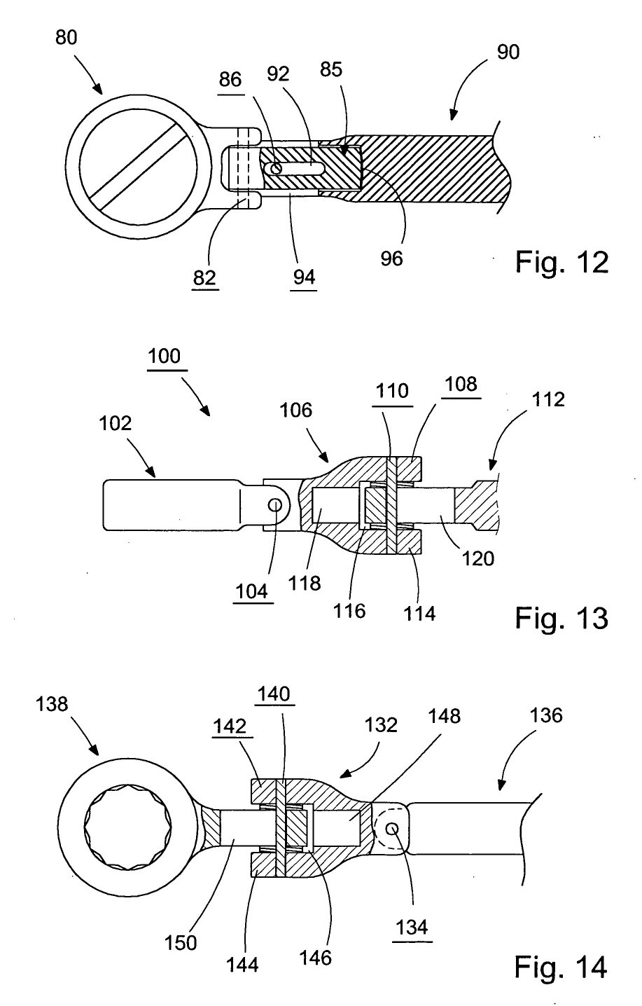

The handle 90 can be moved forward to make the rear end of the connecting member 85 inserted in the cave 96 as shown in FIGS. 11 and 12. At this time, the connecting member is engaged with the handle without possibility of relative rotation. Under such circumstance, the handle and the connecting member can be only up or down swung about the first shaft pin 82. In a wider space, a user can select this operation mode to have higher wrenching torque. In a narrower working site, the wrench can be restored to the state of FIGS. 9 and 10 in which the connecting member 85 is extracted out of the cave 96 of the handle. Under such circumstance, the connecting member and the handle can be rotated relative to each other.

In the embodiment of FIG. 13, the rear end of the head 102 of the wrench 100 is pivotally connected with the front end of the connecting member 106 via the first shaft pin 104. The rear end of the connecting member has a rear connecting portion 108 pivotally connected with the front end of the handle 112 via the second shaft pin 110. The rear connecting portion 108 has an upper and a lower lugs 114 which define therebetween a recess 116. The rear end of the connecting member is further inward recessed from the recess 116 to form a cave 118. The front end of the handle 112 is formed with an axial slot 120 passing through the handle from top face to bottom face thereof. The second shaft pin 110 extends through the rear connecting portion 108 and the slot 120.

When the front end of the handle 112 is not inserted in the cave 120, the handle can be 360 degrees swung. Alternatively, when the front end of the handle is inserted in the cave 120, the handle is engaged with the connecting member 106.

In the embodiment of FIG. 14, the rear end of the connecting member 132 is pivotally connected with the front end of the handle 136 via the second shaft pin 134. The front end of the connecting member is pivotally connected with the rear end of the head 138 via the first shaft pin 140. The front end of the connecting member has a front connecting portion 142 having two lugs 144 which define therebetween a recess 146. The front end of the connecting member is further inward recessed to form a cave 148. The rear end of the head is formed with a slot 150 passing through the head from one side to the other side of the head. The first shaft pin 140 extends through the front connecting portion 142 and the slot 150. In use, the rear end of the head can be inserted into the cave 148 to engage the head with the connecting member 132. Alternatively, the head can be extracted out of the cave.

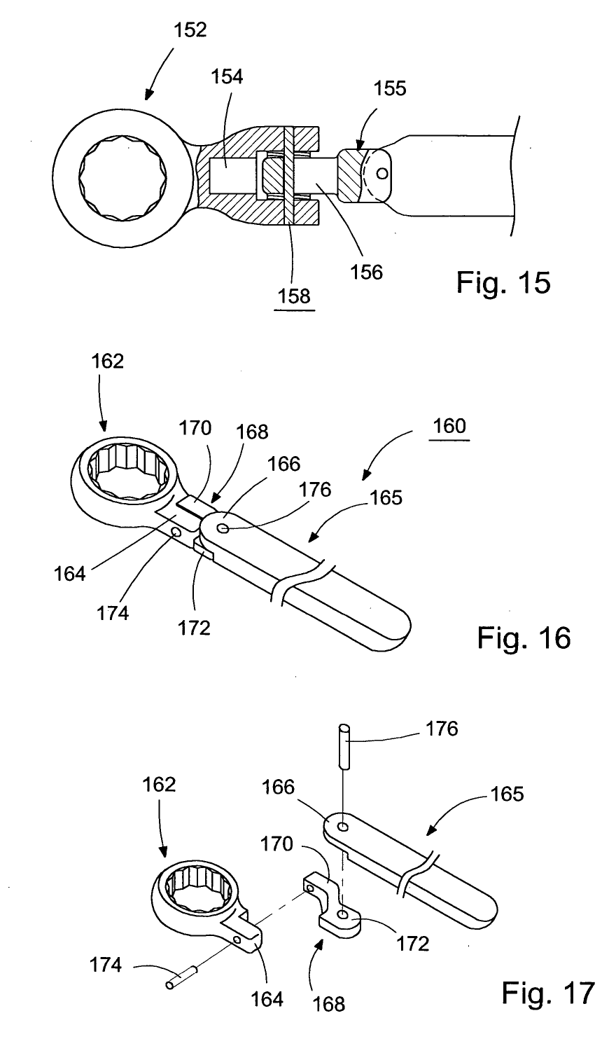

Similarly, in the embodiment of FIG. 15, the rear end of the head 152 is formed with a cave 154. The connecting member 155 is formed with a slot 156. The first shaft pin 158 extends through the head and the slot 156. The front end of the connecting member can be inserted into the cave 154.

FIGS. 16 and 17 show still another embodiment of the wrench 16 of the present invention. The rear end of the head 162 has a first lug 164. The front end of the handle 165 has a second lug 166. The front and rear ends of the connecting member 168 respectively have a front lug 170 and a rear lug 172. The first lug 164 of the head and the front lug 170 of the connecting member are left and right side by side arranged and pivotally connected via the first shaft pin 174. The second lug 166 of the handle and the rear lug 172 of the connecting member are up and down side by side arranged and pivotally connected via the second shaft pin 176. Accordingly, the handle can be 360 degrees swung relative to the head.

In practice, the first lug 164 of the head and the front lug 170 of the connecting member can be up and down side by side arranged and pivotally connected with each other via the first shaft pin 174 which is vertically positioned. The second lug 166 of the handle and the rear lug 172 of the connecting member are left and right side by side arranged and pivotally connected with each other via the second shaft pin 176 which is horizontally positioned.

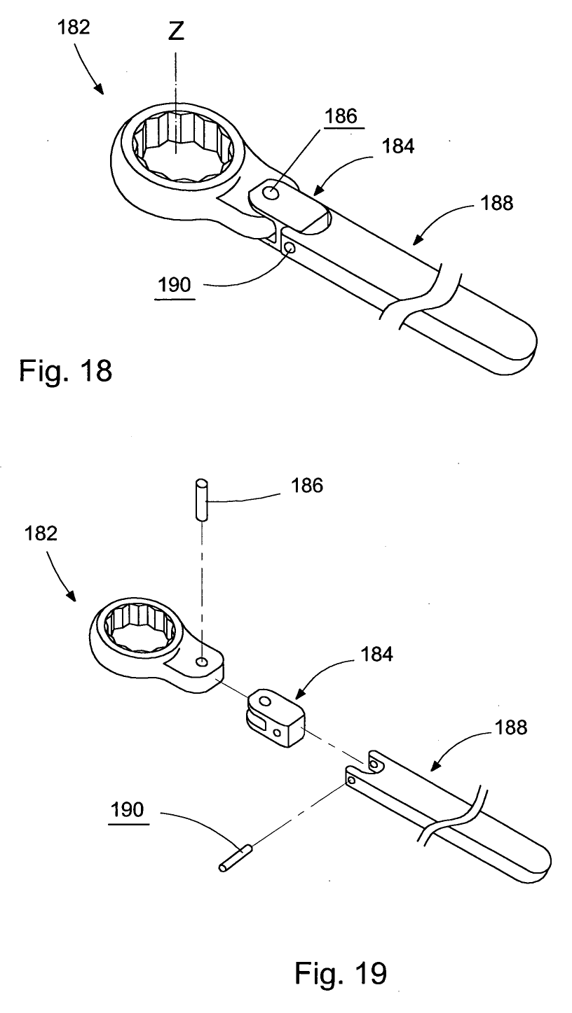

FIGS. 18 and 19 show still another embodiment of the present invention, in which the rear end of the head 182 and the front end of the connecting member 184 are pivotally connected via a vertical first shaft pin 186. The first shaft pin 186 is parallel to the fitting axis Z of the head. The rear end of the connecting member 184 and the front end of the handle 188 are pivotally connected via a horizontal second shaft pin 190. The second shaft pin 190 is perpendicular to the fitting axis Z of the head. Accordingly, the handle can be still 360 degrees swung. When the handle is positioned at a dead end of the swing, the head can be driven.

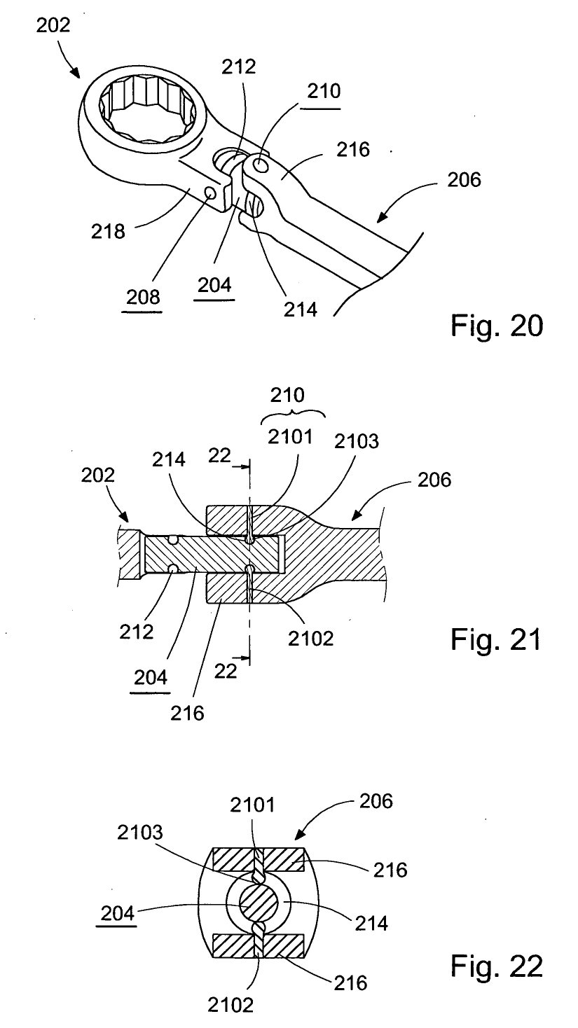

FIGS. 20 to 22 show still another embodiment of the present invention, in which the head 202, the connecting member 204 and the handle 206 are also pivotally connected with each other via the first and second shaft pins 208, 210. The circumferences of front and rear ends of the connecting member are respectively formed with a first and a second annular grooves 212, 214. Each annular groove has a wider inner end and a narrower outer end. Referring to FIGS. 21 and 22, with the second shaft pin 210 exemplified, each shaft pin has two pin bodies 2101, 2102 which are coaxially arranged. One end of each pin body has a bulge portion 2103 with an outer diameter larger than that of the pin body. The two pin bodies 2101, 2102 of the second shaft pin are respectively fitted through the two lugs 216 of the handle 206 with the bulge portions 2103 inlaid in the second annular groove 214. Similarly, the pin bodies of the first shaft pin 208 are fitted through the lugs 218 of the head with the bulge portions inlaid in the first annular groove 212. The handle and the connecting member are relatively rotatable about the second shaft pin. The head and the connecting member are relatively rotatable about the first shaft pin.

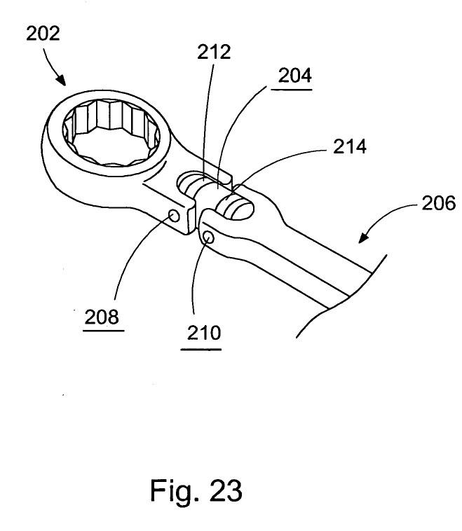

By means of the design of the bulge portion and the annular groove in which the bulge portion is inlaid, the handle can be rotated about the second annular groove 214, while the head can be rotated about the first annular groove 212. Therefore, the two shaft pins 208, 210 can be parallel to each other as shown in FIG. 23. At this time, the handle can be only swung up and down. When the handle is wrenched left or right, the head is driven. However, when the two shaft pins are perpendicular to each other as shown in FIG. 20, the handle can be 360 degrees swung relative to the head.

In conclusion, the handle of the wrench of the present invention can be three-dimensionally swung in accordance with different working sites.

The above embodiments are only used to illustrate the present invention, not intended to limit the scope thereof. Many modifications of the above embodiments can be made without departing from the spirit of the present invention.

What is claimed is:

1. A three-dimensionally operable wrench comprising:
a head for fitting with a screwed member or a socket; and
a handle for a user to hold, said wrench being characterized in that the wrench further comprising:
a connecting member disposed between the head and the handle;
a first shaft pin pivotally connecting a rear end of the head with a front end of the connecting member, whereby the head and the connecting member can be swung relative to each other; and
a second shaft pin pivotally connecting a rear end of the connecting member with a front end of the handle, whereby the connecting member and the handle can be swung relative to each other, the axes of the two shaft pins being perpendicular to each other, whereby the handle can be swung by any angle relative to the head, when the handle is positioned at a dead end of the swing, the handle can be wrenched to drive the head.

2. The three-dimensionally operable wrench as claimed in claim 1, wherein the head has a fitting axis along which the screwed member or the socket is fitted into the head, the first shaft pin being perpendicular to the fitting axis.

3. The three-dimensionally operable wrench as claimed in claim 1, wherein the head has a fitting axis along which the screwed member or the socket is fitted into the head, the first shaft pin being parallel to the fitting axis.

4. The three-dimensionally operable wrench as claimed in claim 1, wherein the pivoted portions of the connecting member and the handle are slidable relative to each other, whereby when the connecting member is moved toward the handle, the connecting member is engaged with the handle without possibility of relative rotation.

5. The three-dimensionally operable wrench as claimed in claim 1, wherein the connecting member is formed with a longitudinal slot passing through the connecting member from one face to the other face of the connecting member, the second shaft pin being fitted through the handle and the slot, whereby the connecting member is slidable relative to the handle, a cave being formed on the front end of the handle, whereby a rear end of the connecting member can be inserted into the cave.

6. The three-dimensionally operable wrench as claimed in claim 1, wherein a front end of the handle is formed with a longitudinal slot passing through the handle from one face to the other face of the handle, the second shaft pin being fitted through the rear end of the connecting member and the slot, whereby the connecting member is slidable relative to the handle, a cave being formed on the front end of the handle, whereby a rear end of the connecting member can be inserted into the cave.

7. The three-dimensionally operable wrench as claimed in claim 1, wherein the pivoted portions of the head and the connecting member are slidable relative to each other, whereby when the connecting member is moved toward the head, the head is engaged with the connecting member without possibility of relative rotation.

8. The three-dimensionally operable wrench as claimed in claim 1, wherein a rear end of the head is formed with a longitudinal slot passing through the head from one face to the other face of the head, the first shaft pin being fitted through the connecting member and the slot, whereby the connecting member is slidable relative to the head, a cave being formed on the front end of the connecting member, whereby a rear end of the head can be inserted into the cave.

9. The three-dimensionally operable wrench as claimed in claim 1, wherein the connecting member is formed with a longitudinal slot passing through the connecting member from one face to the other face thereof, the first shaft pin being fitted through the connecting member and the slot, whereby the connecting member is slidable relative to the head, a cave being formed on the rear end of the head, whereby a front end of the connecting member can be inserted into the cave.

10. The three-dimensionally operable wrench as claimed in claim 1, wherein the rear end of the head has at least one first lug and the front end of the connecting member has at least one front lug, the two lugs being side by side arranged, the first shaft pin being pivotally connected with the first and the front lugs; the rear end of the connecting member has at least one rear lug and the front end of the handle has at least one second lug, the two lugs being side by side arranged, the second shaft pin being pivotally connected with the rear and the second lugs.

11. The three-dimensionally operable wrench as claimed in claim 1, wherein the front end of the handle has two side by side arranged lugs which define therebetween a recess, the rear end of the connecting member being positioned in the recess, the second shaft pin being pivotally connected with the lugs and the connecting member.

12. The three-dimensionally operable wrench as claimed in claim 1, wherein the rear end of the connecting member has two side by side arranged lugs which define therebetween a recess, the front end of the handle being positioned in the recess, the second shaft pin being pivotally connected with the lugs and the handle.

13. The three-dimensionally operable wrench as claimed in claim 1, wherein the front end of the connecting member has two side by side arranged lugs which define therebetween a recess, the rear end of the head being positioned in the recess, the first shaft pin being pivotally connected with the lugs and the head.

14. The three-dimensionally operable wrench as claimed in claim 1, wherein the rear end of the head has two side by side arranged lugs which define therebetween a recess, the front end of the connecting member being positioned in the recess, the first shaft pin being pivotally connected with the lugs and the connecting member.

15. The three-dimensionally operable wrench as claimed in claim 14, wherein a circumferences of the front end of the connecting member is formed with a first annular groove, the first annular groove having a wider inner end and a narrower outer end, the first shaft pin having two pin bodies which are coaxially arranged, one end of each pin body having a bulge portion, the two pin bodies of the first shaft pin being respectively fitted through the two lugs of the head with the bulge portions inlaid in the annular groove of the connecting member.

16. The three-dimensionally operable wrench as claimed in claim 11, wherein a circumferences of the rear end of the connecting member is formed with a second annular groove, the annular groove having a wider inner end and a narrower outer end, the second shaft pin having two pin bodies which are coaxially arranged, one end of each pin body having a bulge portion, the two pin bodies of the shaft pin being respectively fitted through the two lugs of the handle with the bulge portions inlaid in the annular groove of the connecting member.

17. The three-dimensionally operable wrench as claimed in claim 11, wherein the front end of the handle is inward recessed from the recess to form a cave, the connecting member being formed with a longitudinal slot, the second shaft pin being pivotally connected with the two lugs and fitted through the slot, whereby the connecting member can be slid and the rear end of the connecting member can be inserted into the cave.

18. The three-dimensionally operable wrench as claimed in claim 12, wherein the rear end of the connecting member is inward recessed from the recess to form a cave, the front end of the handle being formed with a longitudinal slot, the second shaft pin being pivotally connected with the two lugs and fitted through the slot, whereby the handle can be slid and the front end of the handle can be inserted into the cave.

19. The three-dimensionally operable wrench as claimed in claim 13, wherein the front end of the connecting member is inward recessed from the recess to form a cave, the rear end of the head being formed with a longitudinal slot, the first shaft pin being pivotally connected with the two lugs and fitted through the slot, whereby the head can be slid and the rear end of the head can be inserted into the cave.

20. The three-dimensionally operable wrench as claimed in claim 14, wherein the rear end of the head is inward recessed from the recess to form a cave, the connecting member being formed with a longitudinal slot, the first shaft pin being pivotally connected with the two lugs and fitted through the slot, whereby the connecting member can be slid and the front end of the connecting member can be inserted into the cave.
